(19) United States
(12) Patent Application Publication
(10) Pub. No.: US 2011/0230290 A1
(43) Pub. Date: Sep. 22, 2011

(54) Toothed Chain with Optimized Tooth Plates

(75) Inventors: Stefan Belmer, Anzing (DE); Volker Hirschmann, Furstenfeldbruck (DE)

(73) Assignee: iwis motorsysteme GmbH & Co. KG, Munchen (DE)

(21) Appl. No.: 13/049,723

(22) Filed: Mar. 16, 2011

(30) Foreign Application Priority Data
Mar. 18, 2010 (EP) 10 002 898.4

(51) Int. Cl. F16G 13/04

(52) U.S. Cl. 474/212

(57) ABSTRACT

A toothed chain includes inner chain links and outer chain links alternatingly succeeding one another, the outer chain links comprising at least two outer plates, at least one middle plate and two pins. The inner chain links include at least two inner plates formed as tooth plates, the at least one middle plate being positioned between the inner plates. Each of the inner plates has a plate thickness d and a land width b, a ratio of plate thickness d to land width b being greater than 1.6.

### CROSS-REFERENCE TO RELATED APPLICATION

This application claims priority to foreign European Patent Application EP 10 002 898.4, filed on Mar. 18, 2010, the disclosure of which is incorporated herein by reference in its entirety.

### FIELD OF THE INVENTION

The present invention relates to a toothed chain comprising inner chain links and outer chain links alternatingly succeeding one another, the outer chain links comprising at least two outer plates, at least one middle plate and two pins, the inner chain links comprising at least two inner plates formed as tooth plates, and the at least one middle plate being positioned between the inner plates.

### BACKGROUND

Toothed chains are e.g. used for the control assembly of internal combustion engines. The toothed chain serves as a drive for the camshaft and provides for transmission of the rotational movement from the crankshaft to the cam shaft. Furthermore, auxiliary units of internal combustion engines can also be driven by way of the toothed chain. This may e.g. be the alternator, a pump for servo steering, or an air-conditioning compressor.

The toothed chains in modern internal combustions engines are heavy-duty components that are exposed to great forces during operation of the engine. For instance with changing temperatures, but also with frequent speed changes, a perfect operation must be guaranteed all the time. Moreover, in modern engines, attention is more and more paid to weight reduction and smooth running, so that one constantly aims at optimizing the toothed chains in their function, running characteristics and service lives.

A generic toothed chain is known from the document U.S. Pat. No. 4,906,224. The toothed chain is alternatingly built up of outer chain links and inner chain links. The outer chain link is formed by two guide plates, a middle plate and two pins. Two tooth plates serve as the inner chain link. The middle plate is pressed onto the pins. The tooth plates are twice as thick as the guide or middle plates. The width of the tooth plates in a direction transverse to the extension of the toothed chain is here regarded as the thickness.

A further possible configuration for toothed chains is known from DE 203 04 437 U1. The outer chain links of this toothed chain are formed by two outer plates that are interconnected by two respective pins. A single inner plate serves as the inner chain link, but in comparison with the outer plates it is made much wider than said outer plates. To be more specific, the inner plate is wider than two outer plates taken together.

Bush chains are also known that comprise a bush which extends at least through the inner plates. This configuration, however, leads to noticeable acoustics so that such chains have hardly been used in automotive engineering. It is also known that bush-type toothed chains are used where a bush also extends through the inner plates formed as tooth plates. This complex configuration, however, entails high manufacturing efforts and thus high manufacturing costs, and this is the reason why the car industry tries to avoid the use of such chains because of the enormous cost pressure.

### SUMMARY OF THE INVENTION

The present invention provides a toothed chain that exhibits improved characteristics in comparison with the known embodiments of toothed chains. Chain wear, in particular, is reduced and the fatigue strength is enhanced while the attempt is made to obtain an inexpensive configuration at the same time.

In a generic toothed chain the inner plate can thus have a plate thickness d and a land width b and a ratio of plate thickness d to land width b is greater than 1.6. The plate thickness d is here measured on the plate back in a direction transverse to the longitudinal axis of the toothed chain. The web width b is measured between a pin opening of the inner plate and a tooth flank spaced apart therefrom in force direction, the width being defined as the smallest distance from the tooth flank at a right angle relative to the pin opening. The selected ratio between plate thickness d to land width b yields an advantageous design of the toothed chain with respect to the receivable forces and arising frictions in the chain joint. For instance, the “broad” design of the inner plate achieves a so-called bush effect. Hence, although the toothed chain is without a bush, the design of the toothed chain and the thus existing pin opening yield a friction behavior between inner plates and pins as has otherwise only been possible so far between bushes and pins. It is therefore advantageous to relate the plate thickness with the land width because with an increased plate thickness greater forces can also act on the single inner plate, which forces must be absorbed by the material around the pin opening. Here, the land width has turned out to be the best indicator of the possible forces to be absorbed. Moreover, such a design is advantageous for the reason that the number of shear points on the pins is reduced. If, instead of a broad inner plate, plural small inner plates are used (as a so-called plate package), each of said inner plates exhibits tolerances due to the production process. This has the consequence that the contact forces between a single inner plate and the pin portion respectively in contact therewith are different in each inner plate. The pin is thus differently loaded along its length, which may lead to problems regarding wear and fatigue strength.

To calculate a ratio between two sizes, the first size is divided by the second size. To determine the ratio between plate thickness d and land width b, the plate thickness d is thus divided by the land width b (i.e., d/b).

Alternatively, it is also possible to choose a ratio of plate thickness to land width greater than 1.7 or in a further embodiment greater than 1.75. This permits a further advantageous design of the toothed chain. Compared with the toothed chain having a ratio of 1.6, the configuration of the toothed chain with a ratio of 1.7 or 1.7 means that the land width b is reduced relative to the plate thickness d. Especially with engines in which no or only minor load peaks are transmitted to the toothed chain, it is thereby made possible to use an optimal tooth-plate design for the toothed chain. The land width b can thus be optimized in its material without any negative impact on the fatigue strength of the toothed chain.

Alternatively, it may be provided that the ratio of plate thickness d to land width b is smaller than or equal to 3. It has been found that an arbitrary increase in the ratio of plate thickness d to land width b does not further improve the characteristics of the toothed chain. For instance, it must be feared that with very broad inner plates, i.e. at ratios of plate thickness to land width of more than 3, the necessary lubrication between inner plate and pins can no longer be guaranteed in a safe way.

Furthermore, it may be provided that a ratio of the total thickness of all plates of the inner chain link to the total thickness of all plates of the outer chain link is greater than 1.13. This yields an optimized force transmission or force introduction onto the pins. Moreover, it has been found that, despite the greater overall thickness of all plates of the inner chain link as compared with the overall thickness of all plates of the outer chain link, this does not lead to an excessive load on the outer chain link.

Furthermore, it may be provided that an axis of symmetry which extends along the toothed chain extends through at least one middle plate or between at least two contacting middle plates. The toothed chain is also configured such that in its interior, i.e. in the area of the extension of the symmetry axis, a middle plate or plural middle plates always extend(s) and that an inner plate is positioned to adjoin this plate or these plates at both sides. This accomplishes an optimal force introduction onto the pin and ensures the fatigue strength for the toothed chain.

According to a further embodiment it may be provided that the thickness of the one middle plate or the total thickness of the middle plates is smaller than the plate thickness d of an inner plate. With this design the thickness of a chain wheel into which the toothed chain engages can be kept small. The middle plate need not be configured as a tooth plate by necessity, so that it just serves the force transmission along the chain, but need not get into contact with the chain wheel itself. Therefore, the thinner design of the middle plate does not entail any drawbacks.

Alternatively, it may be provided that the at least one middle plate is configured as a tooth plate. This results in improved behavior as regards the engagement of the toothed chain into an associated chain wheel. The forces arising between chain wheel and toothed chain are transmitted to a larger contact area, which has an advantageous effect on the total service life of toothed chain and chain wheel.

According to a further embodiment, it may be provided that the at least one middle plate is slid onto the pins. Hence, the middle plate is in contact with the pin, but is e.g. not pressed thereonto or undetachably connected to the pin in another way. This ensures a simple manufacturing process and avoids unnecessary costs.

Furthermore, the toothed chain may be designed such that the outer plates are formed as guide plates. Hence, the outer plates are without a toothed shape, but cover the interspace formed by the teeth of a tooth plate. Hence, while a tooth of a chain wheel engages into the tooth plate, the respective tooth is laterally covered by the outer plate, thereby preventing the chain from laterally slipping on the chain wheel. The outer plate formed as the guide plate could thus have an oval shape.

Furthermore, the solution of the object also encompasses an inner plate for a toothed chain for one of the preceding embodiments.

### BRIEF DESCRIPTION OF THE DRAWINGS

The embodiments shall now be described in more detail with reference to the drawings, in which:

FIG. 1 is a schematic illustration of a toothed chain according to the invention with a view on the top side of the inner plates;

FIG. 2 is a view of an inner plate according to the invention from the side;

FIG. 3 is a schematic illustration of an inner plate according to the invention from the top; and

FIG. 4 is a schematic view of a toothed chain with an outer plate configured as a guide plate.

### DETAILED DESCRIPTION

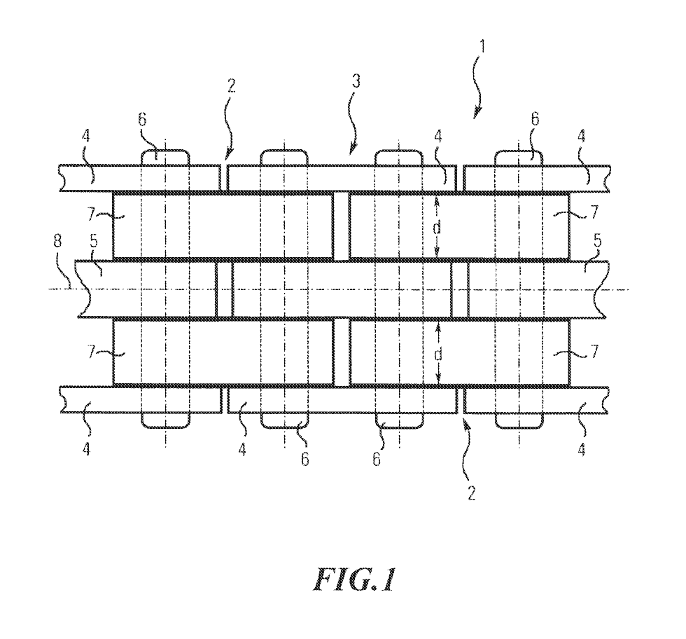

FIG. 1 shows a section of a toothed chain 1 according to the invention. The toothed chain 1 is composed of a plurality of inner chain links 2 and outer chain links 3 alternating along the toothed chain. The outer chain links 3 comprise at least two outer plates 4, at least one middle plate 5 and two pins 6. The inner chain links comprise at least two inner plates 7 formed as tooth plates.

The pins 6 extend in a direction transverse to a symmetry axis or longitudinal axis 8 of the toothed chain 1. On two neighboring pins 6, each pertaining to the same outer chain link 3, a single middle plate 5 is positioned substantially in the middle of the pin 6. The middle plate 5 is slid onto the pins 6, with the pins 6 extending through two pin openings of the middle plate 5. Furthermore, two inner plates 7 are respectively slid onto each pin 6 of an outer chain link 3 to adjoin and contact the middle plate 5. The inner plates 7 also comprise pin openings through which the pins can extend. The inner plates 7 extend along the toothed chain 1 towards a neighboring outer chain link 2 and are connected thereto via a respective pin 6. Hence, one pin 6 of a first outer chain link 2 extends through a first pin opening 15 of the inner plate 7 and a second pin 6 of a second outer chain link 2 through a second pin opening 15 of the inner plate 7. Subsequent to the inner plates 7, the pins 6 have positioned thereon respective outer plates 4 through which the pins 6 also extend. The outer plates 4 can be pressed onto the pins or can be riveted thereto. Hence, the toothed chain 1 is built in symmetry with the longitudinal axis 8.

It is possible according to the invention to use a single middle plate 5 or also a plurality of middle plates 5 in contact with one another as a so-called plate package. In the case of a toothed chain with a single middle plate 5 or in the case of an odd number of plural middle plates 5 the longitudinal axis 8 extends through the middle plate 5 or through one of the middle plates 5. If two middle plates 5 or an even number of middle plates 5 are installed, the longitudinal axis 8 extends between two contacting middle plates 5.

The inner plates 7 have a plate thickness d that differs from the thicknesses of the outer plates 4 and the middle plates 5. The plate thickness d of the inner plates 7 is here chosen to be greater than the respective thicknesses of the remaining plates, i.e. the plates of the outer chain links 2. Especially the thickness of a middle plate 5, or the added total thickness of plural middle plates 5 in contact with one another, is smaller than the plate thickness d of a single inner plate 7. Moreover, the ratio of the added total thickness of all plates of the inner chain member 2 to the added total thickness of all plates of the outer chain link 3 is greater than 1.13. The single middle plate 5 or the plural middle plates 5 can be configured as tooth plates.

The outer chain link 2 is characterized in that there is no relative movement between the plates and the pins 6. There is only a pivotal movement between the inner chain link 3 and the outer chain link 2. As a consequence, the inner plates 7 pivot around the pins 6. The chain links which ensure the flexibility of the toothed chain are thus formed by the inner plates 7 and the pins 6. The broad design of the inner plates 7 enlarges the joint area, i.e. the contact area between an inner plate 7 and a pin 6. This yields a greater joint area than has been possible in the formerly known toothed chains without bushes. Moreover, the broad configuration of the inner plates 7 provides for an even, i.e. ridge-free, joint area. This could so far not been achieved when using a plurality of thin inner plates as a plate package due to the existing manufacturing tolerances.

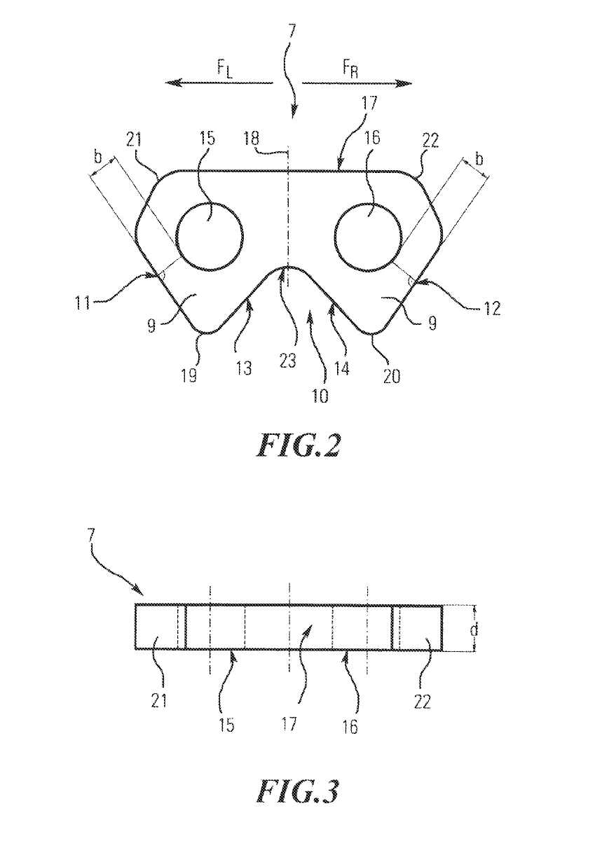

FIG. 2 shows an individual inner plate 7 in a side view. The inner plate 7 is configured as a tooth plate with two teeth 9 between which a chain-tooth receiving means 10 is positioned. A tooth of a chain wheel can engage into the chain-tooth receiving means. The inner plate 7 comprises two outer flanks 11, 12 which can get into contact with a corresponding flank of a chain wheel tooth. Furthermore, the inner plate 7 comprises two inner flanks 13, 14. The inner flanks 13, 14 can be in contact with the flanks of a chain wheel tooth. Furthermore, the inner plate 7 comprises two pin openings 15, 16 through which a corresponding pin 6 extends in the assembled state of the toothed chain 1. A symmetry line 18 with which the inner plate 7 is in mirror symmetry extends from a top side 17 of the inner plate 7 to the chain-tooth receiving means 10. During operation of the toothed chain the inner plates 7 are loaded with the forces F_{R} and F_{L}. These forces are applied by the tensile force which acts on the toothed chain 1 along the axis of symmetry. The forces F_{R} and F_{L} are therefore acting along the inner plate 7 in a direction transverse to the symmetry line 18, e.g. from the symmetry line 18 in the direction of the pin openings 15, 16 and in the direction of the outer flanks 11, 12.

Due to the forces F_{R} and F_{L} the area between the pin openings 15, 16 and the outer flanks 11, 12 represents one of the mostly loaded areas of the inner plates 7. The load bearing capacity of the inner plates 7 is thus also determined by the land width b of the area between the pin openings 15, 16 and the outer flanks 11, 12. The land width b is here dimensioned as the smallest distance between the outer flanks 11, 12 and the pin openings 15, 16. The land width b is here measured at the 90° angle relative to the outer flanks 11, 12. The outer flanks 11, 12 need not be configured as straight flanks by necessity, but may also have a small radius. Likewise, the pin openings 15, 16 need not be made cylindrical by necessity, but may e.g. also have an oval or elliptical contour.

The outer flanks 11, 12 are defined by the flank transitions 19, 20 which are formed as rounded tooth tips. The flank transitions 19, 20 form the boundary and the transition between the outer flank 11 and the inner flank 14 and between the outer flank 12 and the inner flank 14. Furthermore, the outer flanks 11, 12 are defined by transition portions 21, 22. The outer flank 11 passes by means of the rounded transition portion 21 into the top side or the back portion 17. Likewise, the outer flank 12 passes by means of the transition portion 22 into the top side 17. The top side 17 extends in a straight line between the transition portions 21, 22. Furthermore, the inner plate 7 comprises a rounded inner flank portion 23 which forms the transition from the inner flank 13 to the inner flank 14.

FIG. 3 (which is not true to scale) shows the top side 17 of an inner plate 7. The inner plate 7 has a plate thickness d which is measured in a direction transverse to the symmetry axis 8 of the toothed chain 1. The transition portion 21 and the transition portion 22 adjoin both sides of the top side 17.

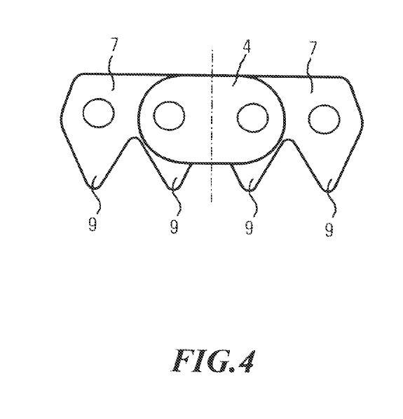

FIG. 4 is a side view of the toothed chain 1, but does not show the pins 6. The toothed chain 1 is completed at the side by an outer plate 4. In the illustrated embodiment the outer plate 4 has an oval shape. The outer plate 4 therefore covers an intermediate portion between two inner plates 7. If the middle plate 5 is configured as a tooth plate, the area of the chain-tooth receiving means 10 of the middle plate 5 is laterally covered by the outer plate 4.

The inner plates can be produced by way of fine blanking or trimming. The straight-cut portion in the pin openings is greater than or equal to 90% of the plate thickness d. On the inner flanks the straight-cut portion is at least 80% of the plate thickness d.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

1. A toothed chain comprising inner chain links and outer chain links alternatingly succeeding one another, the outer chain links comprising at least two outer plates, at least one middle plate and two pins, the inner chain links comprising at least two inner plates formed as tooth plates, which comprise two outer flanks and two pin openings, and the at least one middle plate being positioned between the inner plates,
wherein each of the inner plates has a plate thickness d and a land width b, the land width b being defined as the smallest distance between an outer flank and the nearest pin opening, and a ratio of plate thickness d to land width b being greater than 1.6.

2. The toothed chain according to claim 1, wherein the ratio of plate thickness d to land width b is greater than 1.7, particularly preferably greater than 1.75.

3. The toothed chain according to claim 1, wherein the ratio of plate thickness d to land width b is smaller than or equal to 3.

4. The toothed chain according to claim 1, wherein a ratio of the total thickness of all plates of the inner chain link to the total thickness of all plates of the outer chain link is greater than 1.13.

5. The toothed chain according to claim 1, wherein a symmetry axis which extends along the toothed chain extends through at least a middle plate or between at least two contacting middle plates.

6. The toothed chain according to claim 1, wherein the thickness of the one middle plate or the total thickness of the middle plates is smaller than the plate thickness d of an inner plate.

7. The toothed chain according to claim 1, wherein the at least one middle plate is configured as a tooth plate.

8. The toothed chain according to claim 1, wherein the at least one middle plate is slid onto the pins.

9. The toothed chain according to claim 1, wherein the outer plates are configured as guide plates.

10. An inner plate for a toothed chain, the inner plate comprising two outer flanks and two pin openings, wherein the inner plate has a plate thickness d and a land width b, the land width b being defined as the smallest distance between an outer flank and the nearest pin opening, and a ratio of plate thickness d to land width b being greater than 1.6.
